(19) United States
(12) Patent Application Publication
(10) Pub. No.: US 2014/0114456 A1
(43) Pub. Date: Apr. 24, 2014

(54) Methods and Systems for Clock Correction and/or Synchronization for Audio Media Measurement Systems

(71) Applicant: ARBITRON INC., Columbia, MD (US)

(72) Inventors: John Stavropoulos, Edison, NJ (US); Anand Jain, Ellicott City, MD (US); Wendell Lynch, East Lansing, MI (US); Vladimir Kuznetsov, Ellicott City, MD (US); Jack Crystal, Owings Mills, MD (US); David Gish, Riverdale, NJ (US); Alan Neuhauser, Silver Spring, MD (US)

(73) Assignee: ARBITRON INC., Columbia, MD (US)

(21) Appl. No.: 13/657,275

(22) Filed: Oct. 22, 2012

(51) Int. Cl. G06F 17/00

(52) U.S. Cl. 700/94

(57) ABSTRACT

Systems and methods are disclosed for synchronizing devices that produce identifiable characteristics from audio media. A device receives audio and produces initial time data. Subsequent time data is received at a coupling interface from a portable device that has access to accurate time sources. The subsequent time data is processed to determine if it is more accurate than the initial time data. If so, the clock of the device is updated to reflect the second time data. The device then processes the audio media to generate at least one identifiable characteristic relating to the audio, which may include ancillary codes and/or audio signatures. The identifiable characteristics are then transmitted together with the subsequent time data for detection.

### BACKGROUND

Various technologies are known for measuring media exposure, where an audio component of the media is processed to either (a) extract code that is embedded in the audio, and/or (b) process the audio itself to extract features and form an audio signature or fingerprint. Exemplary techniques are known and described in U.S. Pat. No. 5,436,653 to Ellis et al., titled “Method and System for Recognition of Broadcast Segments,” U.S. Pat. No. 5,574,962 to Fardeau et al., titled “Method and Apparatus for Automatically Identifying a Program Including a Sound Signal,” U.S. Pat. No. 5,450,490 to Jensen et al., titled “Apparatus and Methods for Including Codes in Audio Signals and Decoding,” U.S. Pat. No. 6,871,180, titled “Decoding of Information in Audio Signals,” U.S. Pat. No. 7,222,071 to Neuhauser et al., titled “Audio Data Receipt/Exposure Measurement with Code Monitoring and Signature Extraction,” and U.S. Pat. No. 7,623,823 to Zito et al. titled “Detecting and Measuring Exposure to Media Content Items.” Each of these references is incorporated by reference in its entirety herein.

Obviously, one of the most important aspects of audience measurement in this field of technology is the processing of the audio to insert and detect codes and/or form and detect audio signatures. For audio codes, it is important to ensure that the codes are capable of being inserted into audio with minimal interference with the audio itself (steganographic encoding), while at the same time having sufficient robustness to be easily detected during the decoding process. For audio signatures, it is important to process the audio so that salient features of the audio may be properly extracted to form an audio signature that effectively identifies the underlying audio.

In addition to audio processing, other aspects must be considered as well; for audience measurement involving many devices over a given area, time processing becomes an important consideration. Typically, devices are equipped with a real-time clock, which may be adjusted using technologies such as a time server and/or Network Time Protocol (NTP). Using techniques such as Cristian's Algorithm, a time server keeps a reference time (e.g., Coordinated Universal Time, or “UTC”), and a device (or client) asks the server for a time. The server responds with its current time, and the client uses the received value T to set its clock. Using techniques such as the Berkeley Algorithm, an elected “master” may be used to synchronize clients without the presence of a time server. The elected master broadcasts time to all requesting devices, adjusts times received for “round-trip delay time” (RTT) and latency, averages times, and tells each machine how to adjust. In certain cases, multiple masters may be used.

For NTP, a network of time servers may be used to synchronize all processes on a network. Time servers are connected via a synchronization subnet tree. The “root” of the tree may directly receive UTC information and forward to other nodes, where each node synchronized its time with children nodes. An NTP subnet operates with a hierarchy of levels, or “stratum.” Each level of this hierarchy is assigned a layer number starting with 0 (zero) at the top. The stratum level defines its distance from the reference clock and exists to prevent cyclical dependencies in the hierarchy. Stratum 0 devices exist at the lowest level and include such devices such as atomic (caesium, rubidium) clocks, GPS clocks or other radio clocks. Stratum 1 devices include computers that are attached to Stratum 0 devices. Normally they act as servers for timing requests from Stratum 2 servers via NTP. These computers are also referred to as time servers. Stratum 2 devices include computers that send NTP requests to Stratum 1 servers. Normally a Stratum 2 computer will reference a number of Stratum 1 servers and use the NTP algorithm to gather the best data sample. Stratum 2 computers will peer with other Stratum 2 computers to provide more stable and robust time for all devices in the peer group. Stratum 2 computers normally act as servers for Stratum 3 NTP requests. Stratum 3 devices may employ the same NTP functions of peering and data sampling as Stratum 2, and can themselves act as servers for lower strata. Further statums (up to 256) may be used as needed for additional peering and data sampling. The architecture and operation of various NTP arrangements, along with more comprehensive descriptions may be found at http://www.ntp.org/.

To date, time processing for audio audience measurement has not been sufficiently utilized to provide accurate time measurements and synchronization for audio codes and/or audio signatures. Systems, devices and techniques are needed to ensure time-based data relating to detected codes and/or captured signatures is accurate for proper content identification. Additionally, there are instances where encoding devices and other devices are unwilling or incapable of directly connecting to time-correcting and time-synchronization devices. A configuration is needed to provide additional ways in which encoders and other devices may accurately keep and synchronize time data when monitoring audio.

### SUMMARY

In one embodiment, a method is disclosed for synchronizing a processing device, comprising the steps of receiving an audio signal in the processing device; producing first time data in the processing device; receiving second time data via a coupling interface on the processing device; processing the second time data in the processing device to establish if the second time data is a predetermined type; processing the audio signal in the device in order to generate at least one identifiable characteristic relating to the audio; associating the second time data with the identifiable characteristics if the predetermined type is established; and transmitting the identifiable characteristics together with the associated second time data.

In another embodiment, a processing device is disclosed, comprising an audio interface for receiving an audio signal in the processing device; a processor coupled to the audio interface; a timing device for producing first time data in the processing device; a coupling interface for receiving second time data, wherein the processor (i) processes the second time data to establish if the second time data is a predetermined type, (ii) processes the audio signal to generate at least one identifiable characteristic relating to the audio, and (iii) associates the second time data with the identifiable characteristics if the predetermined type is established; and an output for transmitting the identifiable characteristics together with the associated second time data.

In yet another embodiment, a system is disclosed comprising a portable device comprising a data interface for receiving first time data; a processing device, comprising an audio interface for receiving an audio signal in the processing device; a processor coupled to the audio interface; a timing device for producing second time data in the processing device; a coupling interface for receiving the first time data from the portable device, wherein the processor (i) processes the first time data to establish if the first time data is a predetermined type, (ii) processes the audio signal to generate at least one identifiable characteristic relating to the audio, and (iii) associates the second time data with the identifiable characteristics if the predetermined type is established; and an output for transmitting the identifiable characteristics together with the associated second time data.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a block diagram of a time synchronization system under an exemplary embodiment;

FIG. 2A is an exemplary functional block diagram of a time-domain encoder utilizing time correction/synchronization of the embodiment in FIG. 1;

FIG. 2B is an exemplary functional block diagram of a spectrum-domain encoder utilizing time correction/synchronization of the embodiment in FIG. 1;

FIG. 3A illustrates a block diagram of a spectrum-domain signature extractor utilizing time correction/synchronization under an exemplary embodiment;

FIG. 3B illustrates a block diagram of a time-domain signature extractor utilizing time correction/synchronization under another exemplary embodiment; and

FIGS. 4A and 4B illustrate exemplary time drifts that may be compensated for under the exemplary embodiments disclosed herein.

### DETAILED DESCRIPTION

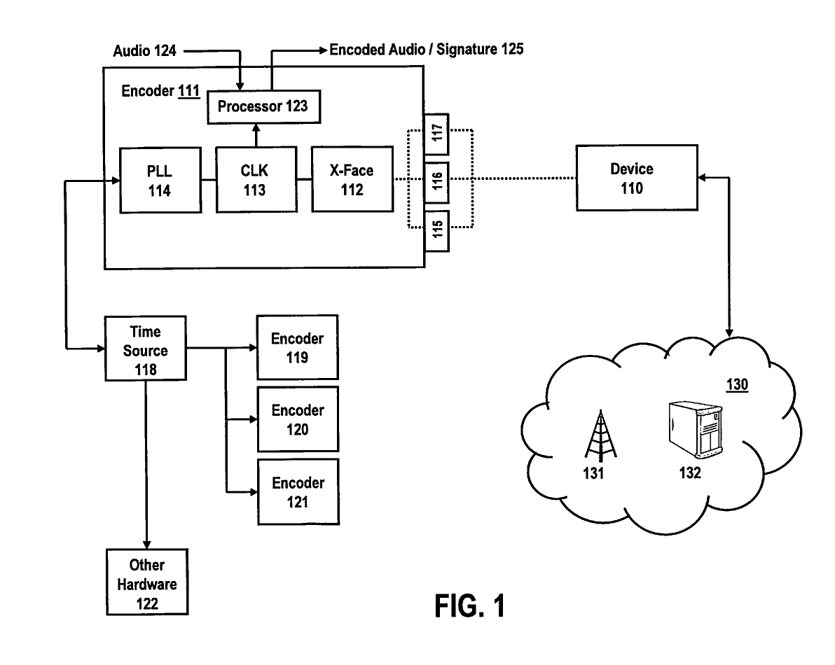

Turning to FIG. 1, an exemplary system is disclosed comprising a time source 118, such as a time server that provides time data in the form of accurate real-time to encoder 111. Time source 118 may be configured to provide time data to other encoders 119-121 and other hardware 122 requiring an accurate time source. Encoders 119-121 may be the same type as encoder 111, or may be different encoders, operating on different audio encoding principles (e.g., spread-spectrum, echo hiding, etc.). Under a preferred embodiment, encoder 111 utilizes an encoding process that inserts inaudible identification codes in an audio signal within a frequency range of approximately 1 kHz to 3 kHz, in part to ensure that the codes will be efficiently reproduced by all kinds of speakers and speaker systems employed by television and radio receivers, as well as other kinds of audio reproducing devices (for example, computers, cell phones, hi-fi systems, etc.) in general use. The codes represent messages that may continuously repeat throughout the duration of the audio signal without interruption so long as the audio signal has the ability to render the codes inaudible by masking them using psychoacoustic masking principles. Since broadcast audio signals normally have a large amount of energy in the 1 kHz to 3 kHz frequency range, codes in this range are masked more effectively by these audio signals than codes in other, higher frequency ranges.

Since the ability of the audio signal to mask the code components when they are reproduced as sound depends on the reproduced audio signal's energy content as its varies with frequency as well as over time, the encoder may analyze the audio signal repeatedly over time by producing data representing its frequency spectrum for a time period extending for only a small fraction of a second. This analysis is performed by a digital signal processor of the encoder, a microcomputer specially programmed to perform the analysis using a fast Fourier transform (FFT) that converts digital data representing the audio signal as it varies over time within such brief time period to digital data representing the energy content of the audio signal within that time period as it varies with frequency. This audio signal energy spectrum extends from approximately 1 kHz to 3 kHz and includes separate energy values of the audio signal within hundreds of distinct frequency intervals or “bins”, each only several Hz wide.

Multiple overlapping messages may be inserted into the audio signal so that all messages are present simultaneously; each such message is regarded as a distinct message “layer.” A first layer may carry a message encoding the identity of the broadcaster, multi-caster, cablecaster, etc., as well as time code data. A second layer is may carry a message encoding a network or content provider that distributes the program. This layer may also includes a time code. A third layer may encode a program identification, but does not necessarily require a time code. The third layer message is particularly useful for identifying content such as commercials, public service announcements and other broadcast segments having a short duration, such as fifteen or thirty seconds.

During encoding, an encoder may evaluate the ability of the audio signal to mask the code components of each message symbol using tonal masking and/or narrow band masking. Each of the two evaluations indicates a highest energy level for each code component that will be masked according to the tonal masking effect or the narrow band masking effect, as the case may be. The encoder assigns an energy level to each code component that is equal to the sum of the two highest energy levels that are masked according to the tonal masking effect and the narrow band masking effect. The masking abilities of the audio signal based both on the tonal masking effect and on the narrow band masking effect are separately determined for each code component cluster. More specifically, for each cluster, a group of sequential frequency bins of the audio signal that fall within a frequency band including the frequency bins of the cluster are used in the masking evaluation for that cluster. Each such group may be several hundred Hz wide. Accordingly, a different group of audio signal frequency bins is used in evaluating the masking ability of the audio signal for each cluster (although the groups may overlap). Additional configurations and other details regarding encoding and decoding processes may be found in U.S. Pat. No. 5,574,962, U.S. Pat. No. 5,450,490, and U.S. Pat. No. 6,871,180 referenced above. It is understood by those skilled in the art that other encoding techniques incorporating time data are equally applicable and are contemplated by the present disclosure.

Continuing with FIG. 1, encoder 111 incorporates the necessary processor hardware and/or software to 123 perform any of the aforementioned encoding processes. Incoming audio 124 is provided from a media source (not shown), and encoded audio 125 is generated at an output from encoder 111. Audio 124 may be part of “audio only” media, or may be part of multimedia data that includes other forms such as video, images, text and the like. Processor 123 is operatively coupled to clock 113, which is further coupled to phase-locked-loop (PLL) circuitry 114 and clock synchronization interface 112. PLL 114 generally assists in clock timing, feedback and phase matching clock 113 with time data provided by time source 118. Clock synchronization interface 112 is connected to one or more coupling interfaces 115-117 that provide one or more external communication interfaces such as Universal Serial Bus (USB), Bluetooth™, WiFi, RS232 and the like. It is understood by those skilled in the art that a single coupling interface may be used, or alternately combined with multiple other interfaces, depending on the specific design of encoder 111.

Device 110 comprises a computer processing device such as a smart phone, a Personal People Meter™, a laptop, a personal computer, a tablet, and the like. Device 110 is configured to communicate, in a wired or wireless manner, with any of coupling interfaces 115-117 of encoder 111. Device 110 is also communicatively coupled to time service network 130 that comprises one or more servers 132 and/or cell towers 131. Network 130 is configured to provide a source of time data that may be used as a primary synchronization point for encoder 111, encoders 119-121 or other hardware 122. Server 132 may include one or more time servers, NTP servers, GPS, and the like.

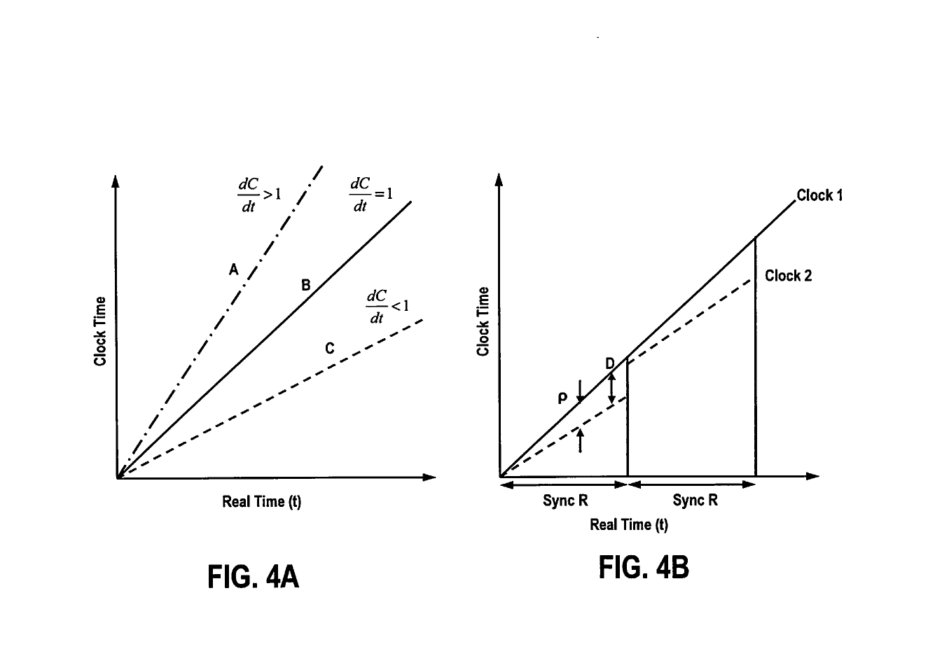

Clock 113 of encoder 111 (as well as clocks of encoders 119-121 and/or other hardware 122) produces a timer that generates an interrupt H times per second. Denoting the value of the encoder clock by Ce(t), where t is accurate (UTC) time, for each encoder, we can determine Ce(t)=t, or, in other words, dC/dt=1. As the encoder physical clock does will not always interrupt exactly H times per second, a drift will inevitably be introduced. Turning briefly to FIG. 4A, this is illustrated by times A-C, where time B designates a perfect clock, time A designates a fast clock, and time C designates a slow clock. As can be seen from the illustration, B (perfect) results in dC/dt=1, while A (fast) results in dC/dt>1 and C (slow) results in dC/dt<1. In certain cases, clocks may run fast and/or slow, resulting in a time skew that can affect encoding, which in turn may affect the accuracy of audience measurement.

When processes x and y are performed on an encoder, cₓ(t) and c_{y}(t) may be used to designate the reading of the clock at each process (x, y) when the real time is t. In this case, the skew may be defined as s(t)=cₓ(t)−c_{y}(t). Turning to FIG. 4B, an illustration is provided where clock 1 is compared against clock 2 experiencing time drift and having a maximum drift rate of p. Here, the maximum drift rate may be expressed as ρt≧|t−cₓ(t)| where (1−ρ)t≦dC/dt≦(1+ρ)t. For each synchronization interval (R), |c_{y}(t)−cₓ(t)|≦2ρt, and |c_{y}(R)−cₓ(R)|≦2ρR≦D, where D designates a synchronization bound, and R≦D/2ρ. To externally synchronize the physical clock for a synchronization bound D>0 for source C_{S} of accurate (UTC) time, the synchronization should result in |C_{S}(t)−Cₓ(t)|<D for x=1, 2, . . . , N and for all real times t. For internal synchronization of a synchronization bound D>0, |Cₓ(t)−C_{y}(t)|<D for x=1, 2, . . . , N and for all real times t.

In the embodiment of FIG. 1, device 110 is configured to receive accurate time from network 130, and forward the received time to encoder 111 for time adjustment via interface 112. Preferably, synchronization clock adjustments are not made abruptly, but are incrementally synchronized. For example, if a timer is set to generate 100 interrupts per second, each interrupt would add 10 ms to the time. To slow down a clock, a timer may be instructed to add 9 ms. To speed up the clock, the timer may be instructed to add 11 ms. It is understood that numerous other time adjustment techniques may be used as well. Under one embodiment, the system of FIG. 1 may be configured such that time data from device 110 overrides time source 118 in encoder 111, resulting in time synchronization in encoder 111 alone. Under another embodiment, time data from device 110 is used to synchronize encoder 111, where, upon synchronization, encoder 111 communicates the synchronization to time source 118, which in turn synchronized encoder 119-121 and/or other hardware 122. Under this embodiment, device 110, device 110 may act as an ad hoc peer in a synchronization subnet to allow one or more devices to synchronize to a more accurate time source than may be available via existing connections. Additionally this configuration has the advantageous effect of allowing encoders having a less accurate time source (e.g., 118) to have access to a more accurate time source (e.g., 130) without requiring a direct, full-time connection. This has a further advantage of providing an accurate time source without requiring costly full-time NTP connections at the encoder end.

Time synchronization between device 100 and encoder 111 may be arranged to be symmetric so that device 100 synchronizes with encoder 111 and vice versa. Such an arrangement is desirable if time source 118 and network 130 are operating within one or more common NTP networks. If one time source is known to be accurate, then it is placed in a different stratum. For example, if time source 118 is known to be more accurate than time from network 130 (e.g., it is a known reference clock), it would communicate as part of stratum 1 through encoder 111. Thus, as device 110 establishes communication with encoder 111 via interface 112, encoder 111 would not synchronize with device 110, and may further provide time data for updating synchronization for network 130. Such communication can take place with a Berkeley Algorithm using a time daemon. A time daemon would poll each device periodically to ask what times are being registered. As each device responds, the time daemon may them compute an average time and tell each respective device to slow down or speed up.

In the embodiment of FIG. 1, time synchronization deployment may be adaptively configured to provide different sources of reference time for encoders and other hardware. Obviously, some dedicated time servers (NTP) with access to an external UTC source is preferred, such as Symmetricom NTS-2000 Stratum 1 servers, which derives UTC time from GPS satellites. These servers may operate on network 130. Additionally, public servers with or without direct access to UTC time are utilized, and may be configured as time source 118 and/or one or more servers (132) residing in network 130. The public servers may be arranges to have open access, restricted access, or closed access, depending on the design needs of the system administrator. Additional local “master” may be used for deployment in FIG. 1 (e.g., device 110), where encoders and/or other devices synchronize their time with the master clock source time.

Under a preferred embodiment, devices connecting with network 130 are enabled with access control to determine who communicates with whom, and what level of service, and/or who will trust whom when advertising time synchronization services. Time synchronization clients (e.g. encoder 111) may be configured to accept some or all of the services from one or more devices or servers or, conversely, to access only select services on a specific device, server or group. One filtering mechanism for time synchronization access control are IP addresses, the type for synchronization service being offered or requested, and the direction of communication. For example, access control could allow an encoder to send time requests but not time synchronization control query requests. Alternately, access control could allow the sending of control query requests without allowing the requestor to synchronize its time with the time source to which the query requests are being sent. The level of granularity in access control may vary as a function of the type of device in which time synchronization is being implemented.

Cryptographic authentication may also be used as a security mechanism for enforcing time synchronization data integrity and to authenticate time synchronization messages and resulting associations. Here, symmetric (private) key cryptography may be used to produce a one-way hash that can be used to verify the identity of a device/peer in a time synchronization network. Under one embodiment, communicating devices may be configured with the same key and key identifier, which, for example, could include a 128-bit key and a 32-bit key identifier. On systems where each participating device is under the direct physical control of an administrator, key distribution could be manual and/or use an Autokey protocol. Key may also be distributed via asymmetric (public) key cryptography where a public key is used to encrypt a time synchronization message, and only a private key can be used to decrypt it (and vice versa).

Autokey protocol is a mechanism used to counter attempts to tamper with accurate and synchronized timekeeping. Autokey may be based on the Public Key Infrastructure (PKI) algorithms from within an OpenSSL library. Autokey relies on the PKI to generate a timestamped digital signature to “sign” a session key. The Autokey protocol may be configured to correspond to different time synchronization modes including broadcast, server/client and symmetric active/passive. Depending on the type of synchronization mode used, Autokey operations may be configured to (1) detect packet modifications via keyed message digests, (2) identify and verify a source via digital signatures, and (3) decipher cookie encryption.

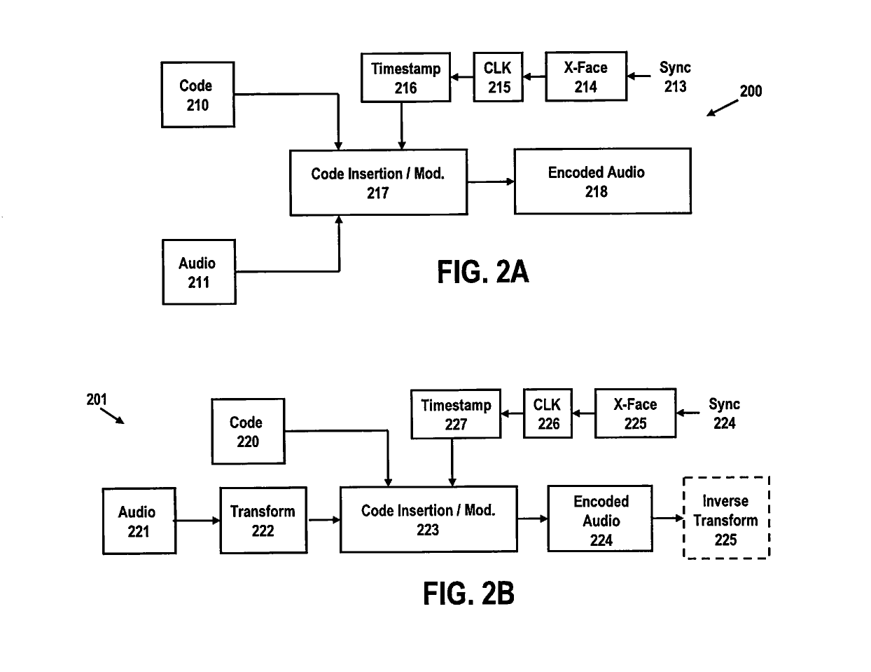

Turning to FIG. 2A, an exemplary time-domain encoding diagram utilizing time synchronization is illustrated, where audio 211 is received at an input of encoder 200, together with one or more codes 210. Code 210 (also referred to in the art as a watermark) may designate broadcaster identification, programming data, or any other information that may be desirable to psychoacoustically insert into audio. As encoder 200 is based on time-domain encoding, code 210 is directly embedded into audio signal, and no domain transform is required. In code insertion/modulation block 217, code 210 is shaped before embedding operation to ensure robustness, and is inserted directly into the audio by adding the code to the audio signal. Shaping the code before embedding enables the encoder to maintain the original audio signal audibility and renders the code inaudible. Suitable techniques for time-domain encoding include low-bit encoding, pulse code modulation (PCM), differential PCM (DPCM) and adaptive DPCM (ADPCM). A synchronization signal 213 is received from a local external source (e.g., device 110), where interface 214 updates the accurate time for clock 215. Time data from clock 215 is used for generating timestamps 216 for embedded code 210 into the audio at block 217, resulting in encoded audio 218.

As time-domain encoding tends to be less robust, frequency-based encoding may be used for inserting code, as shown in FIG. 2B. Similar to FIG. 2A, code 220 is inserted into audio 221. However, in the frequency domain shown in FIG. 2B, the input audio is first transformed to the frequency domain in 222 prior to embedding. Transforming audio 221 from time domain to frequency domain enables encoder 201 to embed the code into perceptually significant components, resulting in a more robust code. There are several different frequency domains, each defined by a different mathematical transformation, which may be used to analyze signals. These include Critical Band Encoding Technology (CBET) developed by Arbitron, Discrete Fourier Transform (DFT), and Discrete Cosine Transform (DCT), which may involve techniques such as phase coding, spread spectrum, and echo data hiding. A synchronization signal 224 is received from a local external source (e.g., device 110), where interface 225 updates the accurate time for clock 226. Time data from clock 226 is used for generating timestamps 227 for embedded code 220 into the audio at block 227, resulting in encoded audio 224. To recover the time stamped code, an inverse transformation 225 is performed on a decoding side.

Various techniques may be used to encode audio for the purposes of monitoring media exposure. For example, television viewing or radio listening habits, including exposure to commercials therein, are monitored utilizing a variety of techniques. In certain techniques, acoustic energy to which an individual is exposed is monitored to produce data which identifies or characterizes a program, song, station, channel, commercial, etc. that is being watched or listened to by the individual. Where audio media includes ancillary codes that provide such information, suitable decoding techniques are employed to detect the encoded information, such as those disclosed in U.S. Pat. No. 5,450,490 and No. 5,764,763 to Jensen, et al., U.S. Pat. No. 5,579,124 to Aijala, et al., U.S. Pat. Nos. 5,574,962, 5,581,800 and 5,787,334 to Fardeau, et al., U.S. Pat. No. 6,871,180 to Neuhauser, et al., U.S. Pat. No. 6,862,355 to Kolessar, et al., U.S. Pat. No. 6,845,360 to Jensen, et al., U.S. Pat. No. 5,319,735 to Preuss et al., U.S. Pat. No. 5,687,191 to Lee, et al., U.S. Pat. No. 6,175,627 to Petrovich et al., U.S. Pat. No. 5,828,325 to Wolosewicz et al., U.S. Pat. No. 6,154,484 to Lee et al., U.S. Pat. No. 5,945,932 to Smith et al., US 2001/0053190 to Srinivasan, US 2003/0110485 to Lu, et al., U.S. Pat. No. 5,737,025 to Dougherty, et al., US 2004/0170381 to Srinivasan, and WO 06/14362 to Srinivasan, et al., all of which hereby are incorporated by reference herein.

Examples of techniques for encoding ancillary codes in audio, and for reading such codes, are provided in Bender, et al., “Techniques for Data Hiding”, IBM Systems Journal, Vol. 35, Nos. 3 & 4, 1996, which is incorporated herein in its entirety. Bender, et al. disclose a technique for encoding audio termed “phase encoding” in which segments of the audio are transformed to the frequency domain, for example, by a discrete Fourier transform (DFT), so that phase data is produced for each segment. Then the phase data is modified to encode a code symbol, such as one bit. Processing of the phase encoded audio to read the code is carried out by synchronizing with the data sequence, and detecting the phase encoded data using the known values of the segment length, the DFT points and the data interval. Bender, et al. also describe spread spectrum encoding and decoding, of which multiple embodiments are disclosed in the above-cited Aijala, et al. U.S. Pat. No. 5,579,124. Still another audio encoding and decoding technique described by Bender, et al. is echo data hiding in which data is embedded in a host audio signal by introducing an echo. Symbol states are represented by the values of the echo delays, and they are read by any appropriate processing that serves to evaluate the lengths and/or presence of the encoded delays.

A further technique, or category of techniques, termed “amplitude modulation” is described in R. Walker, “Audio Watermarking”, BBC Research and Development, 2004. In this category fall techniques that modify the envelope of the audio signal, for example by notching or otherwise modifying brief portions of the signal, or by subjecting the envelope to longer term modifications. Processing the audio to read the code can be achieved by detecting the transitions representing a notch or other modifications, or by accumulation or integration over a time period comparable to the duration of an encoded symbol, or by another suitable technique.

Another category of techniques identified by Walker involves transforming the audio from the time domain to some transform domain, such as a frequency domain, and then encoding by adding data or otherwise modifying the transformed audio. The domain transformation can be carried out by a Fourier, DCT, Hadamard, Wavelet or other transformation, or by digital or analog filtering. Encoding can be achieved by adding a modulated carrier or other data (such as noise, noise-like data or other symbols in the transform domain) or by modifying the transformed audio, such as by notching or altering one or more frequency bands, bins or combinations of bins, or by combining these methods. Still other related techniques modify the frequency distribution of the audio data in the transform domain to encode. Psychoacoustic masking can be employed to render the codes inaudible or to reduce their prominence. Processing to read ancillary codes in audio data encoded by techniques within this category typically involves transforming the encoded audio to the transform domain and detecting the additions or other modifications representing the codes.

A still further category of techniques identified by Walker involves modifying audio data encoded for compression (whether lossy or lossless) or other purpose, such as audio data encoded in an MP3 format or other MPEG audio format, AC-3, DTS, ATRAC, WMA, RealAudio, Ogg Vorbis, APT X100, FLAC, Shorten, Monkey's Audio, or other. Encoding involves modifications to the encoded audio data, such as modifications to coding coefficients and/or to predefined decision thresholds. Processing the audio to read the code is carried out by detecting such modifications using knowledge of predefined audio encoding parameters.

It will be appreciated that various known encoding techniques may be employed, either alone or in combination with the above-described techniques. Such known encoding techniques include, but are not limited to FSK, PSK (such as BPSK), amplitude modulation, frequency modulation and phase modulation. By using the aforementioned time synchronization techniques, audio encoders may provide improved time data which in turn produces more accurate results.

In some cases a signature is extracted from transduced media data for identification by matching with reference signatures of known media data. Suitable techniques for this purpose include those disclosed in U.S. Pat. No. 5,612,729 to Ellis, et al. and in U.S. Pat. No. 4,739,398 to Thomas, et al., each of which is assigned to the assignee of the present application and both of which are incorporated herein by reference in their entireties.

Still other suitable techniques are the subject of U.S. Pat. No. 2,662,168 to Scherbatskoy, U.S. Pat. No. 3,919,479 to Moon, et al., U.S. Pat. No. 4,697,209 to Kiewit, et al., U.S. Pat. No. 4,677,466 to Lert, et al., U.S. Pat. No. 5,512,933 to Wheatley, et al., U.S. Pat. No. 4,955,070 to Welsh, et al., U.S. Pat. No. 4,918,730 to Schulze, U.S. Pat. No. 4,843,562 to Kenyon, et al., U.S. Pat. No. 4,450,551 to Kenyon, et al., U.S. Pat. No. 4,230,990 to Lert, et al., U.S. Pat. No. 5,594,934 to Lu, et al., European Published Patent Application EP 0887958 to Bichsel and PCT publication WO91/11062 to Young, et al., all of which are incorporated herein by reference in their entireties.

An advantageous signature extraction technique transforms audio data within a predetermined frequency range to the frequency domain by a transform function, such as an FFT. The FFT data from an even number of frequency bands (for example, eight, ten, sixteen or thirty two frequency bands) spanning the predetermined frequency range are used two bands at a time during successive time intervals. When each band is selected, the energy values of the FFT bins within such band and such time interval are processed to form one bit of the signature. If there are ten FFT's for each interval of the audio signal, for example, the values of all bins of such band within the first five FFT's are summed to form a value “A” and the values of all bins of such band within the last five FFT's are summed to form a value “B”. In the case of a received broadcast audio signal, the value A is formed from portions of the audio signal that were broadcast prior to those used to form the value B. To form a bit of the signature, the values A and B are compared. If B is greater than A, the bit is assigned a value “1” and if A is greater than or equal to B, the bit is assigned a value of “0”. Thus, during each time interval, two bits of the signature are produced.

One advantageous technique carries out either or both of code detection and signature extraction remotely from the location where the research data is gathered, as disclosed in US Published Patent Application 2003/0005430 published Jan. 2, 2003 to Ronald S. Kolessar, which is assigned to the assignee of the present application and is hereby incorporated herein by reference in its entirety.

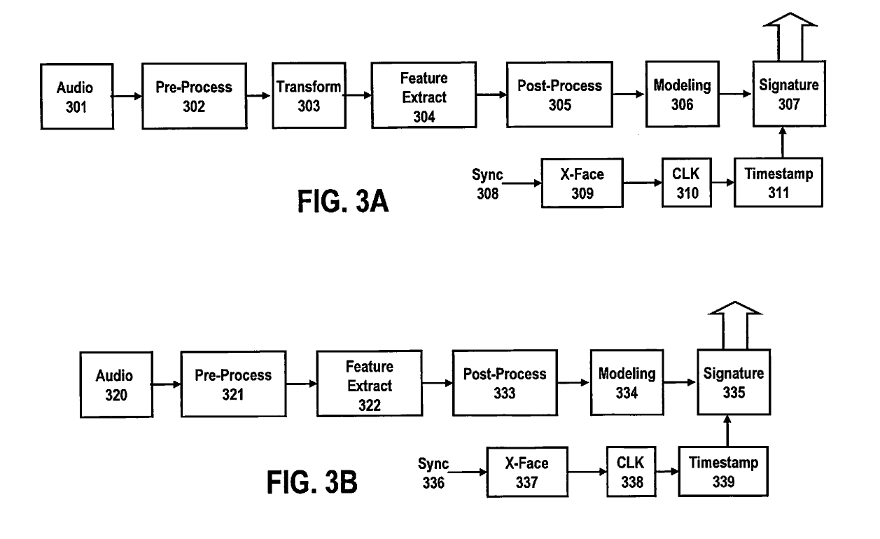

Turning to FIG. 3A, an exemplary embodiment is provided where incoming audio is pre-processed 301 for the generation of a frequency-based audio signature (307). For pre-processing, the audio is digitalized (if necessary) and converted to a general format, such as raw format (16 bit PCM) at a certain sampling rate (e.g., 44.1 KHz). Filtering, such as band-pass filtering, may be performed, along with amplitude normalization, as is known in the art. The signal may further be divided into frames of a size comparable to the variation velocity of underlying acoustic events to produce a given frame rate. A tapered window function may be applied to each block, and overlap is applied to ensure robustness to shifting. Afterwards, a transform 303 is performed on the pre-processed audio to convert it from the time domain to the frequency domain. Suitable transforms include FFT, DCT, Haar Transform and Walsh-Hadamard Transform, among others.

After a transform is applied, feature extraction block 304 identifies perceptually meaningful parameters from the audio that may be based on Mel-Frequency Cepstrum Coefficients (MFCC) or Spectral Flatness Measure (SFM), which is an estimation of the tone-like or noise-like quality for a band in the spectrum. Additionally, features extraction 304 may use band representative vectors that are based on indexes of bands having prominent tones, such as peaks. Alternately, the energy levels of each band may be used, and may further use energies of bark-scaled bands to obtain a hash string indicating energy band differences both in the time and the frequency analysis. In post-processing 305, temporal variations in the audio are determined to produce feature vectors, and the results may be normalized and/or quantized for robustness.

Fingerprint modeling 306 receives a sequence of feature vectors calculated from 305 and processes/models the vectors for later retrieval. Here, the vectors are subjected to (distance) metrics and indexing algorithms to assist in later retrieval. Under one embodiment, multidimensional vector sequences for audio fragments may be summarized in a single vector using means and variances of multi-bank-filtered energies (e.g., 16 banks) to produce a multi-bit signature (e.g., 512 bits). In another embodiment, the vector may include an average zero-crossing rate, an estimated beats per minute (BPM), and/or average spectrum representing a portion of the audio. In yet another embodiment, modeling 306 may be based on sequences (traces, trajectories) of features to produce binary vector sequences. Vector sequences may further be clustered to form codebooks, although temporal characteristics of the audio may be lost in this instance. It is understood by those skilled in the art that multiple modeling techniques may be utilized, depending on the application and processing power of the system used. Once modeled, the resulting signature 307 is stored and ultimately transmitted for subsequent matching.

Continuing with FIG. 3A, a synchronization signal 308 is received from a local external source (e.g., device 110), where interface 309 updates the accurate time for clock 310. Time data from clock 310 is used for generating timestamps 311 for signatures extracted in 307. As the timestamp is based on an accurate time, subsequent identification of the audio signature can be made with greater confidence. Audio signatures are preferably generated in encoder 111, but may also be generated in device 110 or other hardware 122.

Turning to FIG. 3B, an alternate embodiment is disclosed where time-domain audio signatures are formed utilizing clock correction. Here, audio 320 is subjected to pre-processing in 321, where the audio is digitalized (if necessary) and converted to a general format, such as raw format (16 bit PCM) at a certain sampling rate (e.g., 44.1 KHz). Filtering, such as band-pass filtering, may be performed, along with amplitude normalization, as is known in the art. The signal may further be divided into frames of a size comparable to the variation velocity of underlying acoustic events to produce a given frame rate. Next, audio features are extracted directly from the processed audio frames, where, unlike the embodiment of FIG. 3A, the audio is not subjected to a transform. Salient audio features include zero-crossings for audio in the given frames, peaks, maximum peaks, average frame amplitude, and others. Once extracted, post-processing 333 may further process features by applying predetermined thresholds to frames to determine signal crossings and the like. Similar to FIG. 3A, modeling 334 is performed to determine time-based characteristics of the audio features to form audio signature 335, which is stored and ultimately transmitted for matcing.

Synchronization signal 336 is received from a local external source (e.g., device 110), where interface 337 updates the accurate time for clock 338. Time data from clock 338 is used for generating timestamps 339 for signatures extracted in 335. Again, utilizing clock synchronization techniques such as those described above increases the accuracy of the subsequent identification of the audio signatures produced. Audio signatures of FIG. 3B are preferably generated in encoder 111, but may also be generated in device 110 or other hardware 122.

Although various embodiments have been described with reference to a particular arrangement of parts, features and the like, these are not intended to exhaust all possible arrangements or features, and indeed many other embodiments, modifications and variations will be ascertainable to those of skill in the art.

What is claimed is:

1. A method for synchronizing a processing device, comprising the steps of:
receiving an audio signal in the processing device;
producing first time data in the processing device;
receiving second time data via a coupling interface on the processing device;
processing the second time data in the processing device to establish if the second time data is a predetermined type;
processing the audio signal in the device in order to generate at least one identifiable characteristic relating to the audio;
associating the second time data with the identifiable characteristics if the predetermined type is established; and
transmitting the identifiable characteristics together with the associated second time data.

2. The method of claim 1, wherein the at least one identifiable characteristic comprises ancillary code embedded into the audio.

3. The method of claim 2, wherein the embedded ancillary code is substantially inaudible in the audio signal.

4. The method of claim 3, wherein the ancillary code comprises information that identifies at least one of (i) content relating to the audio signal and (ii) a source of the audio signal.

5. The method of claim 1, wherein the at least one identifiable characteristic comprises an audio signature, said audio signature comprises data identifying at least one of (i) frequency-based characteristics and (ii) time-based characteristic of the audio signal.

6. The method of claim 1, wherein the processing of the second time data comprises the step of establishing if the second time data originated from a predetermined IP address.

7. The method of claim 1, wherein the processing of the second time data comprises the step of establishing if the second time data has a hierarchical rank that is higher than the first time data.

8. The method of claim 1, wherein the coupling interface comprises one of (i) a Bluetooth interface, (ii) a WiFi interface, (iii) a USB interface, and (iv) a RS-232 interface.

9. A processing device, comprising:
an audio interface for receiving an audio signal in the processing device;
a processor coupled to the audio interface;
a timing device for producing first time data in the processing device;
a coupling interface for receiving second time data, wherein the processor
(i) processes the second time data to establish if the second time data is a predetermined type,
(ii) processes the audio signal to generate at least one identifiable characteristic relating to the audio, and
(iii) associates the second time data with the identifiable characteristics if the predetermined type is established; and
an output for transmitting the identifiable characteristics together with the associated second time data.

10. The device of claim 9, wherein the at least one identifiable characteristic comprises ancillary code embedded into the audio.

11. The device of claim 10, wherein the embedded ancillary code is substantially inaudible in the audio signal.

12. The device of claim 11, wherein the ancillary code comprises information that identifies at least one of (i) content relating to the audio signal and (ii) a source of the audio signal.

13. The device of claim 9, wherein the at least one identifiable characteristic comprises an audio signature, said audio signature comprises data identifying at least one of (i) frequency-based characteristics and (ii) time-based characteristic of the audio signal.

14. The device of claim 9, wherein the processor processes the second time data to establish if the second time data originated from a predetermined IP address.

15. The device of claim 9, wherein the processor processes the second time data to establish if the second time data has a hierarchical rank that is higher than the first time data.

16. The device of claim 9, wherein the coupling interface comprises one of (i) a Bluetooth interface, (ii) a WiFi interface, (iii) a USB interface, and (iv) a RS-232 interface.

17. A system, comprising:
a portable device comprising a data interface for receiving first time data
a processing device, comprising
an audio interface for receiving an audio signal in the processing device;
a processor coupled to the audio interface;
a timing device for producing second time data in the processing device;
a coupling interface for receiving the first time data from the portable device, wherein the processor (i) processes the first time data to establish if the first time data is a predetermined type, (ii) processes the audio signal to generate at least one identifiable characteristic relating to the audio, and (iii) associates the second time data with the identifiable characteristics if the predetermined type is established; and
an output for transmitting the identifiable characteristics together with the associated second time data.

18. The system of claim 17, wherein the at least one identifiable characteristic comprises ancillary code embedded into the audio.

19. The system of claim 17, wherein the at least one identifiable characteristic comprises an audio signature, said audio signature comprises data identifying at least one of (i) frequency-based characteristics and (ii) time-based characteristic of the audio signal.

20. The system of claim 17, wherein the processor processes the second time data to establish if the second time data has a hierarchical rank that is higher than the first time data, and wherein the coupling interface comprises one of (i) a Bluetooth interface, (ii) a WiFi interface, (iii) a USB interface, and (iv) a RS-232 interface.
